(19) United States
(12) Patent Application Publication
(10) Pub. No.: US 2026/0229920 A1
(43) Pub. Date: Aug. 6, 2026

(54) PORTABLE COMPUTER WITH WIRELESS CHARGING SYSTEM

(71) Applicant: EVJAM LLC, Minneapolis, MN (US)

(72) Inventors: Steven DICKE, Minneapolis, MN (US); Gregg KROMREY, Hudson, WI (US)

(73) Assignee: EVJAM LLC, Minneapolis, MN (US)

(21) Appl. No.: 19/466,405

(22) Filed: Jan. 31, 2026

Related U.S. Application Data
(60) Provisional application No. 63/751,993, filed on Jan. 31, 2025.

(51) Int. Cl. H02J 50/10; H02J 50/00

(52) U.S. Cl. CPC H02J 50/10; H02J 50/005

(57) ABSTRACT

One or more examples provide a portable computer including a wireless charging system for charging one or more electronic devices and methods. In one or more examples, a charging transmitter is located within the computer housing. The wireless charging system includes a transmitter circuit coupled to a transmitter coil, where when the wireless charging system is activated the transmitter coil operates to inductively couple to a device located on the computer housing and operationally aligned with the transmitter coil for charging the device.

### CROSS-REFERENCE TO RELATED APPLICATIONS

This application claims the benefit of the filing date of U.S. Provisional Application Ser. No. 63/751,993, filed Jan. 31, 2025, which is incorporated herein by reference.

### TECHNICAL FIELD

The present disclosure relates generally to portable computers and wireless charging systems and devices.

### BACKGROUND

Many battery operated electronic devices require almost daily charging. These devices are typically personal devices, including phones, tablets, and watches. Often, these devices each have unique charging port configurations that require charging plugs that are specific to each device. Many of these devices can also be charged wirelessly, without the need for specific charging port requirements.

A typical wireless charging device includes a device charging pad that plugs into an electric source such as an electrical outlet, computer port or hub. Although no specific charging plug configuration is required, the device wireless charger and power cord take additional desk or counter space for charging the electronic device.

For these and other reasons, there is a need for the present invention.

### SUMMARY

The present disclosure provides one or more examples of a portable computer having a wireless charging system. In one or more examples, the wireless charging system is in or integrated into the portable computer housing.

Additional and/or alternative features and aspects of examples of the present technology will become apparent from the following description and the accompanying drawings.

### BRIEF DESCRIPTION OF THE DRAWINGS

The Figures generally illustrate one or more examples of a portable computer including a portable computer configured as a wireless charging system.

FIG. 1 is a diagram illustrating one example of a portable computer including a wireless charging system.

FIG. 2 is a diagram illustrating one example of a wireless charging system.

FIG. 3 is a diagram illustrating one example of the portable computer system including a wireless charging system of FIG. 1 used as part of a computer system workstation.

FIG. 4 is a diagram illustrating one example of a portable computer including a wireless charging system in a closed position.

FIG. 5 is a diagram illustrating one example of a portable computer including a wireless charging system in an open position.

FIG. 6 is a diagram of a top view illustrating one example of a portable computer including a wireless charging system.

FIG. 7 is a diagram illustrating one example of a portable computer including a wireless charging system.

FIG. 8 is a diagram illustrating one example of a portable computer including a wireless charging system.

FIG. 9 is a diagram illustrating one example of a portable computer including a wireless charging system.

FIG. 10 is a front view illustrating another example of a portable computer including a wireless charger.

FIG. 11 is a block diagram illustrating one example of a portable computer including a wireless charging system.

FIG. 12 is a block diagram illustrating one example of a portable computer including a wireless charging system.

FIG. 13 is a diagram illustrating one example of a portable computer including a wireless charging system showing a charging operation of a device.

FIG. 14 is a diagram illustrating one example of a portable computer including a wireless charging system showing alternate charging locations.

FIG. 15 is a diagram illustrating one example of a portable computer including a wireless charging system with multiple transmitter coils.

FIG. 16 is a block diagram illustrating one example of a portable computer including a wireless charger with multiple transmitter coils.

FIG. 17 is a diagram illustrating one method of operating the portable computer with a wireless charger.

FIG. 18 is a diagram illustrating another method of operating the portable computer with a wireless charger including multiple transmitter coils.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

### Portable Computer Having a Charging System-Overview

The present disclosure provides a portable computer with a wireless charging system and method. The portable computer is configured to inductively couple to a device needing a charge. The portable computer is able to charge one or more devices without the use of cords. This charging system provides for easier charging of user devices, and keeps a users desktop free of messy charging cables or cords. An electronic device is wirelessly charged from the computer power system. In one example, an electronic device positioned on the computer can be charged when the computer is plugged into AC power (e.g., an electrical outlet). In another example, when the computer is unplugged it can be charged directly from the computer battery system.

### Portable Computer With Wireless Charging System

One or more examples of a portable computer with a wireless charging system are detailed herein and illustrated in the following Figures.

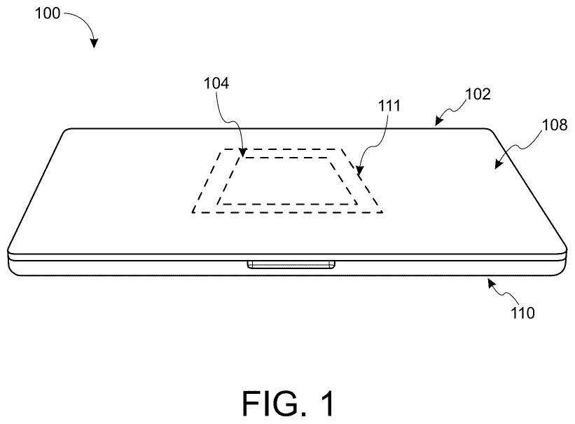

FIG. 1 is a diagram illustrating one example of a portable computer including a wireless charging system generally at 100. The portable computer 100 is illustrated in a closed position. The portable computer 100 is configured as a wireless charger for charging electronic devices.

In one example, the portable computer 100 includes a computer housing 102 and a wireless charging system 104. The wireless charging system 104 is positioned within the computer housing 102. When the wireless charging system 104 is activated, the wireless charging system 104 inductively couples to a device (not shown) positioned on the computer housing 102. The wireless charging system 104 operates to wirelessly charge the device.

In one example, the portable computer 100 activates the wireless charging system 104. For example, the portable computer 100 can activate the wireless charging system 104 when the computer 100 is in a closed position. Further, the portable computer 100 can activate the wireless charging system 104 when the portable computer 100 is in a closed position and is powered either via an AC power source or battery powered. The computer 100 includes a housing cover 108 and a housing body 110. In order to charge a device (e.g., a mobile phone), one simply sets the device on top of the portable computer 100 cover 108 in an area proximate to the wireless charger 104. In one example, the wireless charger 104 is located near a central area 111 of the cover 108 (and just below the housing).

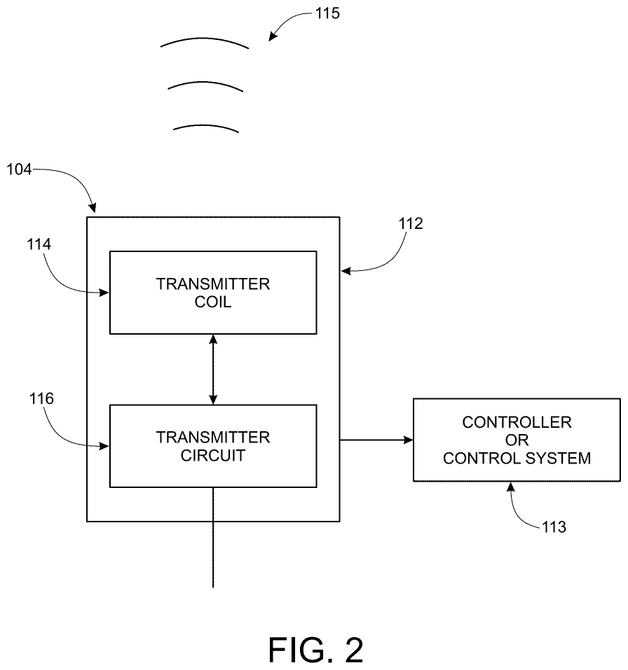

FIG. 2 is one example of a block diagram of wireless charger 104. The wireless charging system 104 includes a charging transmitter 112. The charging transmitter 112 is coupled to a controller 113. Controller 113 can be a separate controller located within charging system 104 near charging transmitter 112, or be part of the portable computer 100 control system. Controller 113 aids in controlling operation of charging transmitter 112. In one example, controller 113 aids in activating wireless charging system 104 for performing a charging operation.

In one or more examples, the charging transmitter 112 includes a transmitter coil 114 and a charging transmitter circuit 116. The transmitter coil 114 is coupled to the transmitter circuit 114. In operation, the charging circuit is located just below the computer housing 102 or formed integral the computer housing 102.

In one example, the transmitter coil 114 is located immediately below the computer housing cover 108. In another example, the transmitter coil 114 is located at least partially within the housing cover 108. In the example of FIG. 1, the transmitter coil 114 is located proximate the center of the computer cover 108 in central area 111. In operation, when the wireless charging system 104 is activated, the transmitter coil 114 operates to wirelessly couple (i.e., inductively couple) to a device located on the computer housing 102 and operationally aligned with the transmitter coil to perform a charging operation as represented by magnetic field wireless signal lines 115.

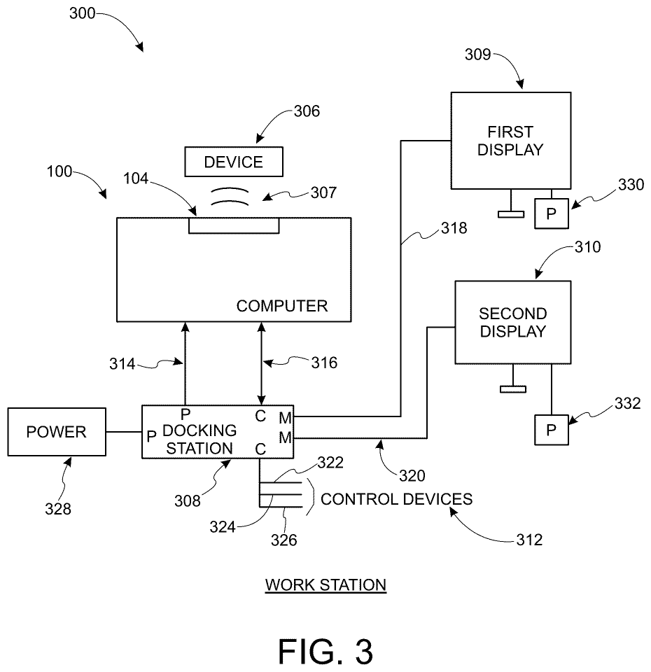

FIG. 3 is a diagram illustrating the portable computer 100 having a wireless charging system 104 as part of a larger computer system 300. In one example, the setup of computer system 300 is similar to that of a desktop workstation. Portable computer 100 includes wireless charging system 104. While in use as a workstation, portable computer 100 is available and operates to wirelessly charge device 306.

For examples illustrated herein, device 306 is commonly illustrated as a mobile phone. It is recognized that device 306 could be other portable devices suitable for wireless charging. For example, the device 306 could be wireless headphones, earpods, or a watch configured for wireless charging.

In one example, computer system 300 includes docking station 308, first display 309, second display 310, and control devices 312. In one or more examples, control devices 312 can include a keyboard, a computer mouse, and microphone, a camera, or other workstation device. Docking station 308 is coupled to computer 100 via power connection 314 and control connection 316. First display 309 is coupled to docking station 308 via monitor communication link 318. Second display 310 is coupled to docking station 308 via monitor communication link 320. Control devices 312 are coupled to docking station 308 via control links 322, 324, 326. Docking station 308 is powered via power input 328. First display 310 is powered via power 330. Second display 312 is powered via power input 332.

In operation, portable computer 100 is operably coupled to docking station 308 at power connection 314 and at control connection 316. Portable computer 100 is in a closed position. Portable computer 100 operates to provide control and processing power to workstation computer system 300 while the portable computer 100 is in a closed position. Additionally, when in an active closed position portable computer 100 is available to operate as a wireless charger for devices 306 positioned on the portable computer 100.

To wirelessly charge a device 306, the device 306 is simply set down on the portable computer 100 in the location of wireless charging system 104, as detailed herein. Wireless charging system 104 provides a wireless charging signal to device 306 as illustrated at 307. In one example operation, wireless charging system 104 includes a charging transmitter that provides (i.e., transmits) a magnetic field (illustrated as wireless charging signal 307) to device 306. Device 306 includes a charging receiver that inductively couples to the wireless charging system 104 to receive the charging signal 307. The charging signal 307 in the form of a magnetic field induces a charging current in the device 306 charging receiver.

As such, while portable computer 100 operates to provide processing power to workstation 300. The computer 100 is also available to wirelessly charge one or more devices (e.g., device 306) positioned on the portable computer 100. It is very easy to use the wireless charger by simply setting a device 306 on the portable computer 100 in the location of the wireless charging system 104.

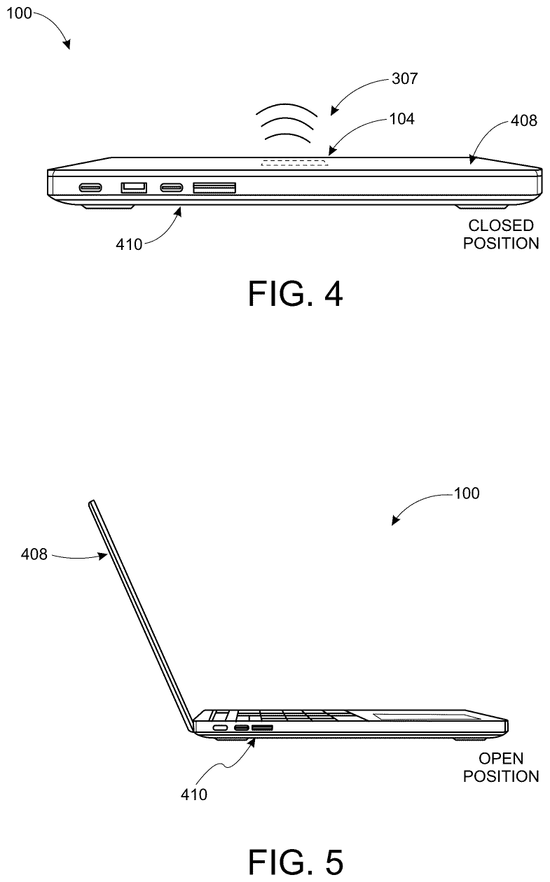

FIG. 4 illustrates portable computer 100 including wireless charging system 104 operable as a wireless charger. Computer 100 includes a cover 408 and a computer body 410. Computer 100 is illustrated in a closed position. In the closed position, computer 100 sits flat with computer cover 408 positioned against computer body 410. When computer 100 is in a closed position, the wireless charging system is activated and in an active mode. When the computer housing 102 is in a closed position, wireless charging system 104 is available to wirelessly charge a device positioned on the housing 102 over the wireless charging system 104 as indicated by charging signal 307.

FIG. 5 illustrates a portable computer 100 in an open position. When in an open position, the computer cover 408 is rotated upward relative to the computer body 410 inactivating the wireless charging system. In one example, once the portable computer 100 housing 102 is opened, the portable computer 100 is available for use as an operable computer. Power is removed from the wireless charging system and the wireless charging system is in an inactive mode. The computer 100 is in an open position and the portable computer display contained in cover 408 is available for use.

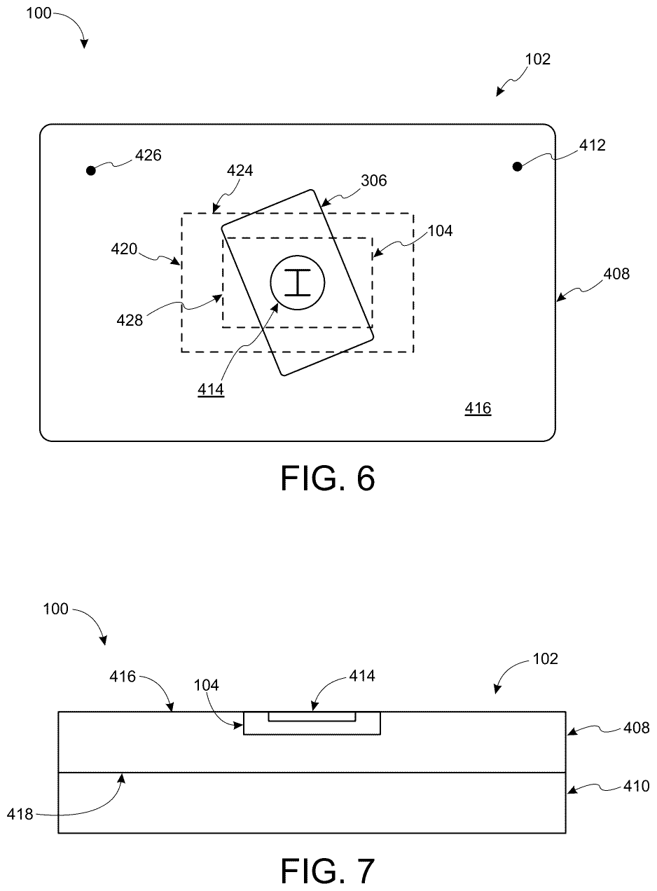

FIGS. 6-9 illustrate one or more examples of the wireless charging system 104, and are further detailed herein in the following paragraphs. In one example, the wireless charging system 104 transmitter coil 114 is located beneath the cover 408. In another example, the transmitter coil is integrated into the housing of cover 408. The charging coil can be located proximate a central area of the cover 408 or outside a central area of cover 408.

FIG. 6 is a diagram illustrating one example of a top view of portable computer 100. FIG. 7 is a diagram illustrating one example of a front view of the computer 100 of FIG. 6, when the computer 100 is in a closed position. Reference is made to FIG. 6 and FIG. 7 in the following paragraphs of the specification.

In one example, the portable computer 100 includes a logo or other indicia 414 on the cover housing 412. The charger transmitter (e.g., charger transmitter coil) for the portable computer 100 wireless charging system 104 is located below the indicia 414. The indicia 414 operates as a locator of the wireless charging system charging transmitter for a user.

In one example, the cover 408 includes a top side 416 and a bottom side 418. A computer display is located on the cover 108 bottom side 418. Cover 408 includes a cover housing 412. The transmitter coil 114 is located beneath the cover housing 412 on top side 416. In one example, the transmitter coil 114 is located below and within a central area 420 of the housing cover top side 416.

In one example, the computer cover housing 412 top side 416 includes a first area 424 and a second area 426, where the first area 424 includes a charging area 428. Charging area 428 is defined as the area where a device 306 can be positioned on the computer cover 408 for wireless charging of the device.

In one example, the first area 424 is larger than the charging area 428. In another example, the first area 424 is close to the same size as the charging area. In one example, the cover housing 412 first area 424 has a first area thickness, and the second area 426 has a second area thickness, where the first area thickness in the charging area 428 is less than the second area thickness. This allows enhanced transmission (e.g., magnitude) of the electromagnetic field in the charging area 428, while maintaining a strong structural integrity of the cover 108 due to an increased thickness in the second area 426.

In one example, the charging area 428 is made of a first material composition and the second area 426 is made of a second material composition, where the first material composition is more magnetically transmissive than the second material composition. The first material composition may also include a magnetic amplification material layer that aids in inductively coupling the wireless charging system 104 to a device being charged.

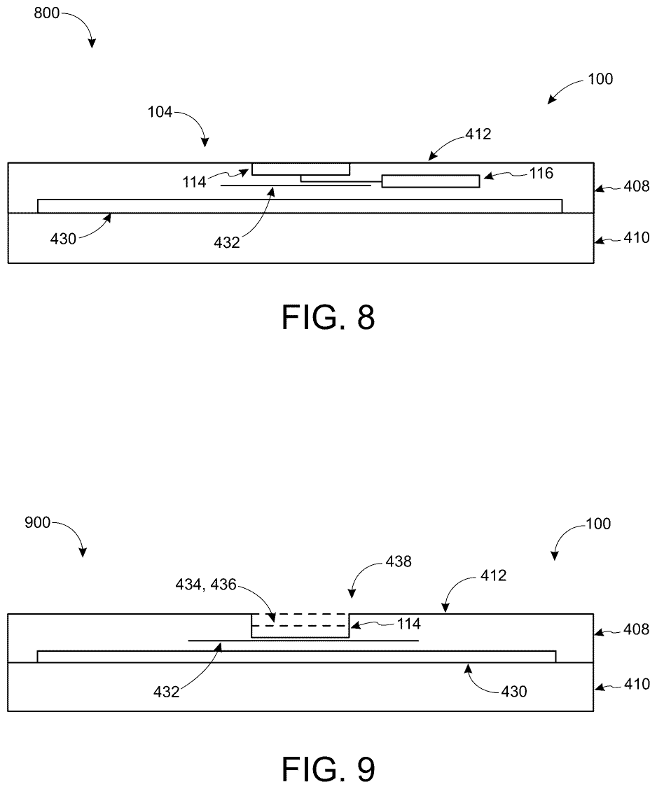

FIG. 8 is a front view illustrating one example of a portable computer including a wireless charging system generally at 800. In one example, the wireless charging system 104 includes a charging transmitter 112 having transmitter coil 314 and transmitter circuit 116. The transmitter coil 114 and transmitter circuit 116 are located within the portable computer cover housing 412. In particular, they are located just below the computer housing 412, between the computer housing 412 and the computer display system 430. In one example, a shielding layer or shielding material 432 is located below the wireless transmitter 114. In examples, the shielding layer or material 432 is located between the wireless transmitter 114 and the computer display 430. The shielding layer or material 432 operates to shield the magnetic field associated with the charger transmitter 112 from the rest of the computer systems.

FIG. 9 is a side view illustrating another example of a portable computer 100 including a wireless charger generally at 900. In this example, the charger transmitter coil 114 is located in the center of the cover housing 412. At this location, the cover housing 412 is thinner relative to the rest of the cover housing. In another example, the computer housing 412 includes a material 434 different from the rest of the cover housing for enhanced transmission of the charger magnetic field. In yet another example, a magnetically permeable or magnetic field amplification material 436 is located at the location of the transmitter coil. In another example, an indicia is located proximate the location of the charging transmitter that operates as both an indicia and signifies the location of the charging transmitter.

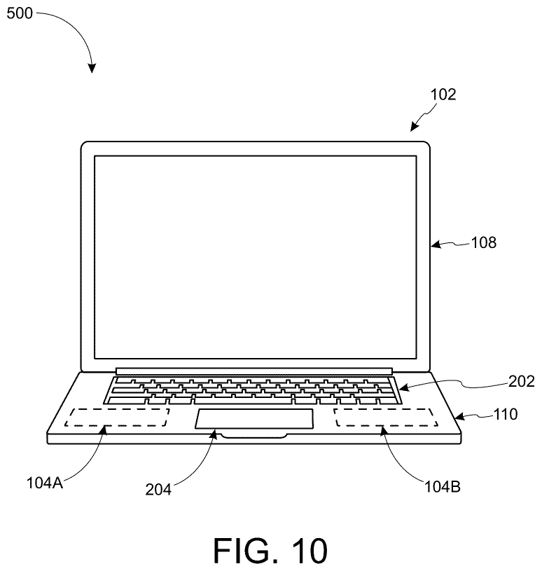

FIG. 10 is a diagram illustrating one example of the portable computer system 100 of FIG. 1 in an open position generally at 500. In one example, when the portable computer 100 is in an open position the wireless charging system 104 is inactive and the portable computer system 100 is available for use for its intended purpose.

In one example, a wireless charging system or an additional wireless charger transmitter is located in the computer housing body. In one example illustrated, the wireless charging system is located in an area below the keyboard 202 and on a side of the mousepad 204, illustrated as wireless charging system 104A and wireless charging system 104B. Wireless charging system 104A and wireless charging system 104B are similar to the wireless charging system 104 detailed herein.

In this example, once the portable computer 100 is in an open position, the wireless charging system 104A and/or 104B is activated. A user can charge their device by simply setting it on the housing body 110 over the wireless charging areas 104A or 104B. The device needing a charge inductively couples to the wireless charging system transmitter coil as detailed herein. In one example, the device 306 includes a receiver coil for inductive coupling to the wireless charging system 104A, 104B transmitter coil.

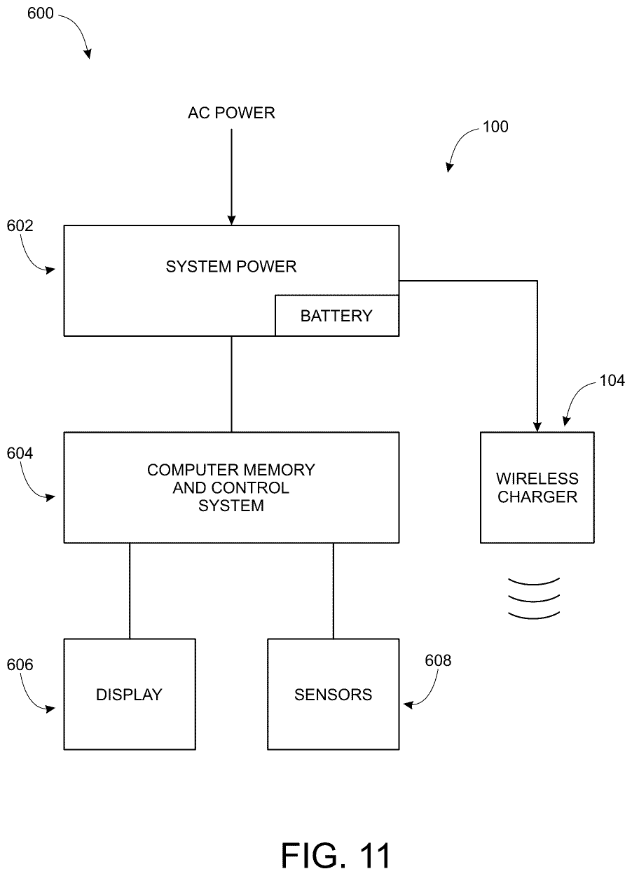

FIG. 11 is a diagram illustrating one example of a portable computer 100 including a wireless charger 104 generally at 600. The portable computer block diagram 600 includes a computer memory and control system 604, sensors 608, display system 606, computer system power 602, and charging system 104. The charging system 104 includes a transmitter circuit coupled to a transmitter coil as detailed herein. In one example, the charging system is coupled to the computer system power. The charging system may or may not be directly coupled to the computer battery via the transmitter circuit.

In one example, the wireless charger 104 is only activated when the portable computer is plugged into AC power. In another example, the charging circuit is also active when the portable computer is not coupled to AC power. For example, the charging circuit may be active for a period of time after the cover is shut. Upon detection of a device requesting a charge, the charging circuit may stay active until the device is fully charged. Alternatively, the charging circuit may be activated and controlled using a phone application linked to the portable computer. The mobile phone activation can communicate with the portable computer using a wireless communication link, such as Bluetooth, BLE, or other communication protocol.

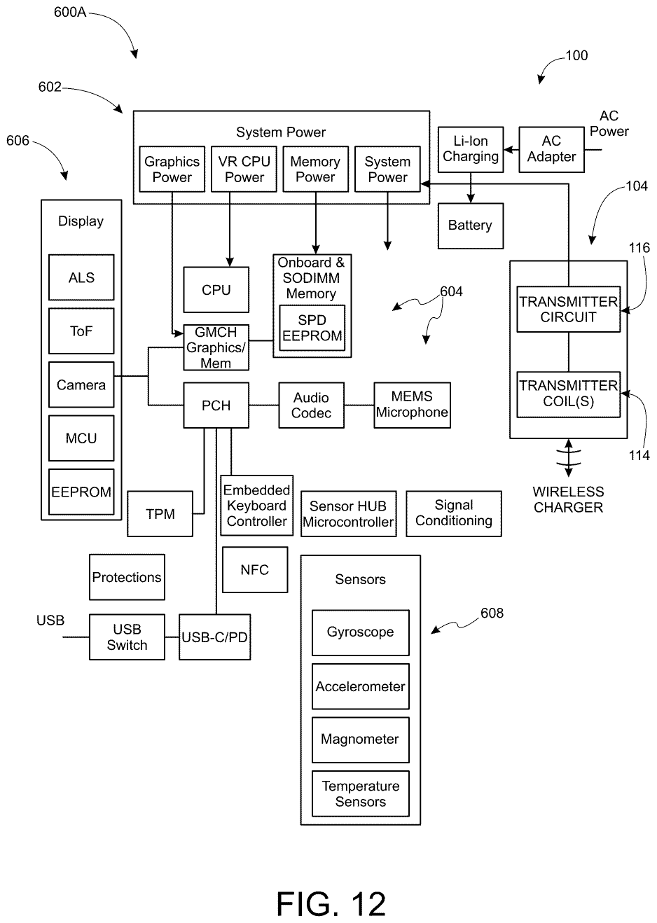

FIG. 12 is another diagram illustrating one example of a portable computer system including a wireless charger generally at 600A. One example of a detailed block diagram of a portable computer 100 including a wireless charging system is illustrated. The wireless charger 104 (e.g., for inductive charging) includes one or more transmitter coils coupled to a transmitter circuit as detailed herein. In examples, the wireless charger is operatively coupled to the computer battery or the computer system power.

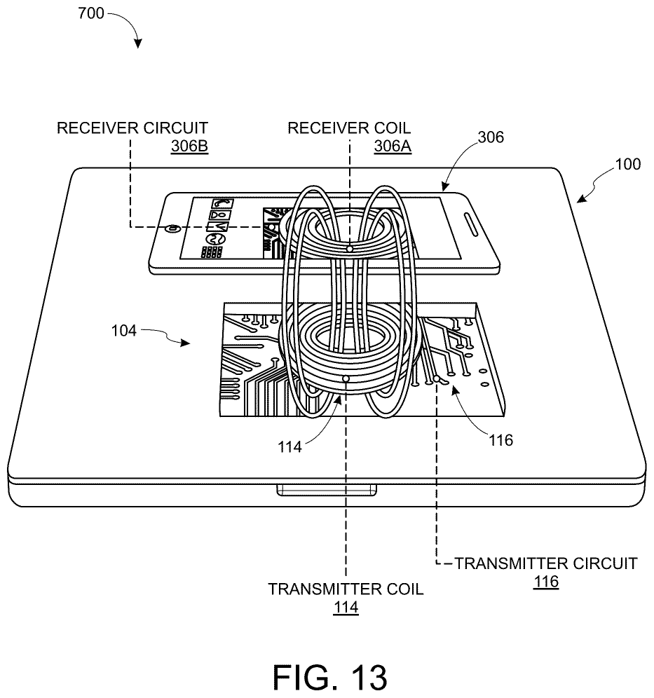

FIG. 13 is a diagram illustrating one example of a portable computer system including a wireless charger in operation generally at 700. In operation, a device 306 that needs a charge is set on the computer cover, positioned over the charging transmitter 114. The computer DC voltage is converted to an alternating current (AC) voltage. In one example, it is a high frequency AC voltage. An alternating current is sent to the charging transmitter 114 either from the computer or from an AC power source. In particular, the alternating current is sent to the charging transmitter coil 114 via the transmitter circuit 116. The alternating current flowing within the transmitter coil 114 creates a magnetic field (e.g., referred to a charging signal herein) which extends to the receiver coil 306A of the device 306 needing a charge. The device 306 to be charged is inductively coupled to the portable computer 100 charging transmitter 114. The magnetic field 307 generates a current within the receiver coil 306A of the device 306. Current flowing within the receiver coil 306A of the device being charged (e.g., a portable phone, watch, or other device) is converted into direct current by the receiver circuit 306B, charging the battery of the device 306.

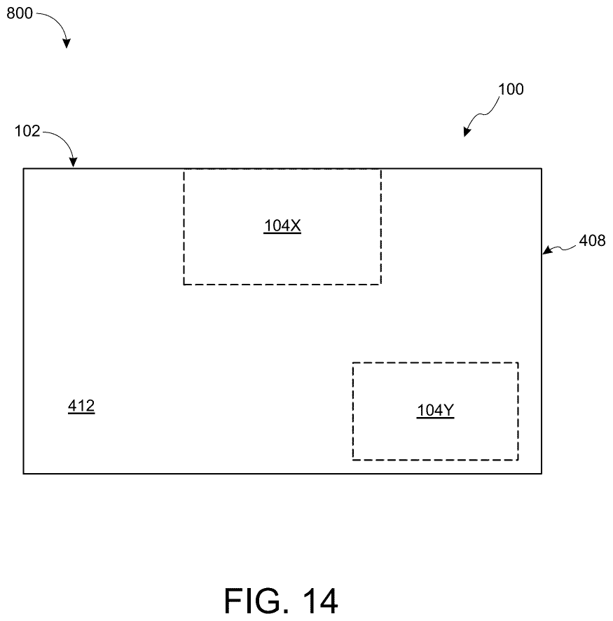

FIG. 14 is a diagram illustrating one example of a portable computer 100 including a wireless charger 104 further illustrating alternate charger locations generally at 800. In one or more examples illustrated, the wireless charging system 104 can be located at multiple locations (e.g., 104X, 104Y) below the portable computer housing 102.

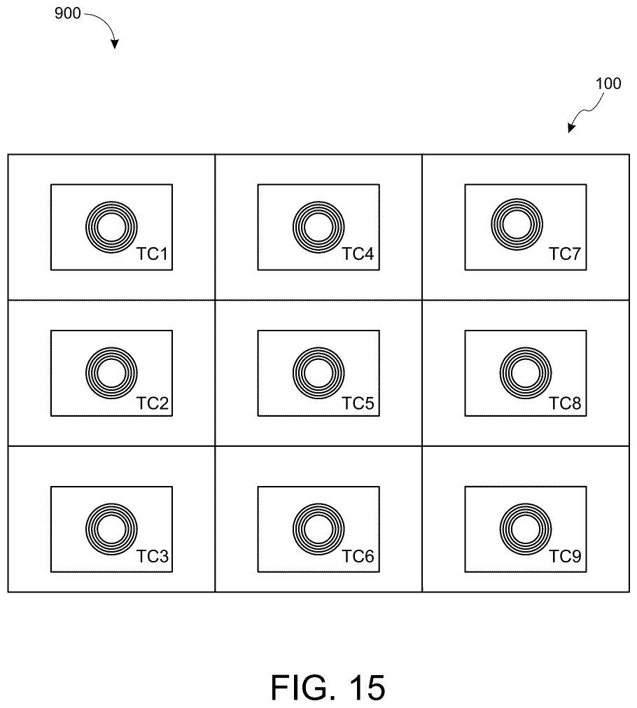

FIG. 15 is a top view diagram illustrating one example of a portable computer 100 including a wireless charger 104 with multiple transmitter coils generally at 900. In one example illustrated, multiple transmitter coils TC1, TC2, TC3, TC4, TC5, TC6, TC7, TC8, TC9 are located below the portable computer housing 412. When a device to be charged is set on the computer cover, the transmitter circuit detects which transmitter coil TC1, TC2, TC3, TC4, TC5, TC6, TC7, TC8, TC9 is located closest to the device using the wireless charger controller or the computer 100 control system and proceeds to charge the device using the closest transmitter coil.

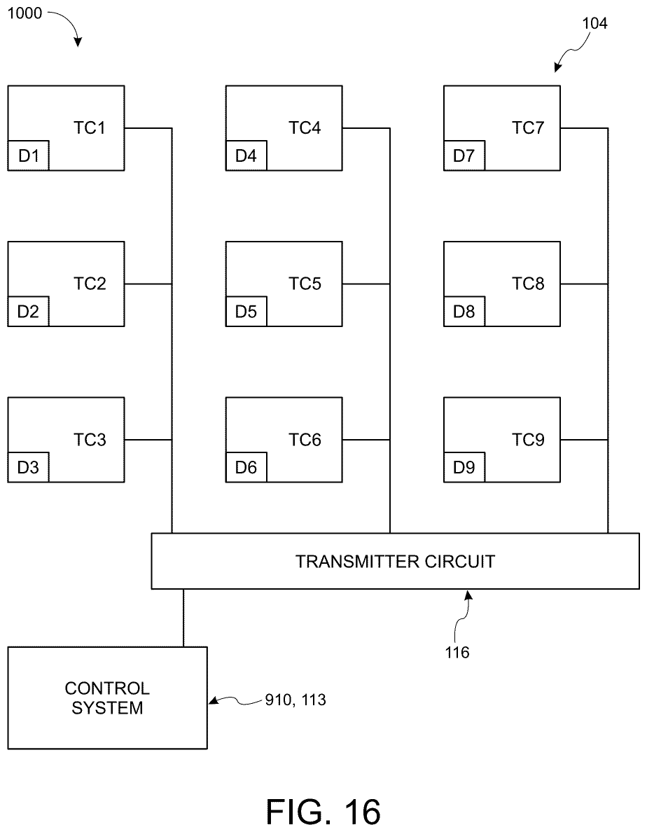

FIG. 16 is a block diagram illustrating one example of a portable computer including the wireless charger with multiple transmitter coils of FIG. 15, generally at 1000. This system 1000 allows charging of a device positioned or set one of the multiple charging locations D1, D2, D3, D4, D5, D6, D7, D8, D9 associated with computer 100.

In one example, when a charging operation is to be performed, charging control system 910 initiates a coil selection process by sequentially activating each transmitting coil TC1, TC2, TC3, TC4, TC5, TC6, TC7, TC8, TC9 of the array of transmitting coils(i.e., one transmitting coil at a time). In response, the control system 910, 113 monitors an amount of energy transferred to the device receiving coil from each individual transmitting coil, wherein the amount of energy transferred is indicative of the alignment between a given transmitting coil TC1, TC2, TC3, TC4, TC5, TC6, TC7, TC8, TC9 and the device receiving coil(s) (i.e., the greater the amount of energy transferred the better the alignment). Based on the amount of energy transferred from each transmitting coil TC1, TC2, TC3, TC4, TC5, TC6, TC7, TC8, TC9, the charging controller 910, 113 begins charging the battery of the device needing a charge by selectively energizing those transmitting coils which are best aligned with the receiving coil(s). In some examples, the charging controller selectively energizes only those transmitting coils which provide an amount of energy transfer above a predetermined threshold level. In some examples, such a predetermined threshold level may be a percentage (e.g., 50%, 70%, 80%, etc.) of a maximum amount of energy a given transmitting coil may transfer if fully aligned with a receiving coil of a device requesting a charge.

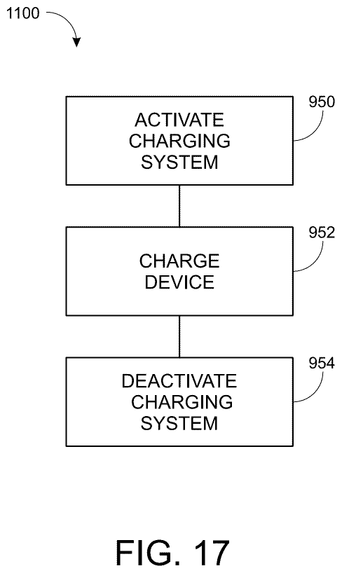

FIG. 17 is a diagram illustrating one method of operating the portable computer with a wireless charger generally at 1100 and as detailed herein. At block 950, the charging system is activated. At block 952, a device is charged. At block 954, the charging system is deactivated. For example, the charging system can be deactivated once a device is charged or once the portable computer cover is opened.

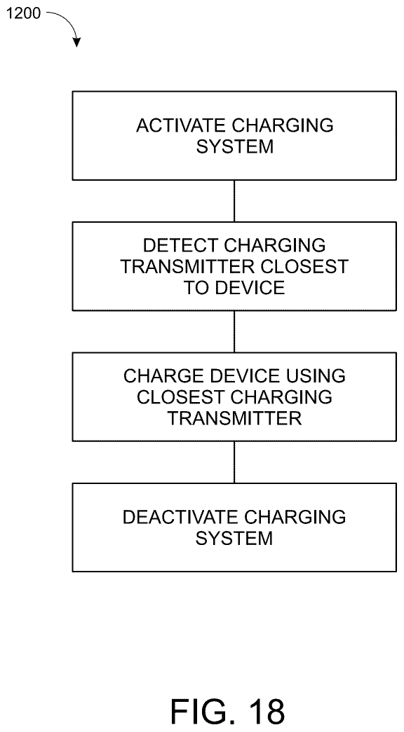

FIG. 18 is a diagram illustrating another method of operating the portable computer with a wireless charger including multiple transmitter coils generally at 1200 and as detailed herein.

One or more examples are illustrated in the following paragraphs.

A first example provides a portable computer. The portable computer includes a computer housing. A wireless charging system is within the computer housing. The wireless charging system includes a transmitter circuit coupled to a transmitter coil, where when the wireless charging system is activated the transmitter coil operates to inductively couple to a device located on the computer housing and operationally aligned with the transmitter coil.

In one example, the computer housing includes a housing cover and a housing body, where the housing cover includes a top side and a bottom side, where a computer display is located on the bottom side. The housing cover where the transmitter coil is located beneath the housing cover on the top side. In one example, the transmitter coil is integrated into the housing cover.

In one example, the transmitter coil is located proximate to a central area of the housing cover top side.

In one example, the top side of the computer housing includes an indicia, where the transmitter coil is located directly below the indicia.

In one example, the portable computer comprises an electromagnetic shield layer located within the computer housing between the wireless charger and the computer display.

In one example, the computer housing topside includes a first area and a second area, where the first area includes a charging area. In one example, the computer housing first area has a first area thickness and the second area has a second area thickness, where the first area thickness in the charging area is less than the second area thickness.

In one example, the charging area is made of a first material composition and the second area is made of a second material composition, where the first material composition is more magnetically transmissive than the second material composition. In one example, the second material composition includes a magnetic amplification layer that aids in magnetically coupling the wireless charging system to a device to be charged.

In one example, the wireless charging system includes a second transmitter coil. The second transmitter coil is located beneath the housing cover on the top side.

In another example, the transmitter coil is located within the computer body housing. In one example, the computer body housing includes a keyboard area and a mouse pad area, where the transmitter coil is located within the computer body housing outside of the keyboard area and the mousepad area.

In one example, the portable computer includes a power system, where the computer power system is coupled to the wireless charging system.

A second example is a portable computer. The portable computer includes a computer housing. A wireless charging system is within the computer housing. The wireless charging system includes a transmitter circuit coupled to a transmitter coil, where when the wireless charging system is activated the transmitter coil operates to inductively couple to a device located on the computer housing and operationally aligned with the transmitter coil. The computer housing includes a housing cover and a housing body, where the housing cover includes a top side and a bottom side, where a computer display is located on the bottom side.

A computer power system is coupled to the wireless charging system. The computer power system provides AC power to the wireless charging system. In one example, when the portable computer is not connected to an AC power supply, AC power is provided to the wireless charging system via a computer battery system.

A third example provides a portable computer. The portable computer includes a computer housing. A wireless charging system is within the computer housing. The wireless charging system includes a transmitter circuit coupled to multiple transmitter coils, where when the wireless charging system is activated one of the multiple transmitter coils operates to inductively couple to a device located on the computer housing and operationally aligned with the transmitter coil.

In one example, the computer housing includes a housing cover and a housing body, where the housing cover includes a top side and a bottom side, where a computer display is located on the bottom side, and where the multiple transmitter coils are located beneath the housing cover on the top side.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The claims are part of the specification.

1. A portable computer comprising:
a computer housing:
a wireless charging system within the computer housing, the wireless charging system including a transmitter circuit coupled to a transmitter coil, where when the wireless charging system is activated the transmitter coil operates to inductively couple to a device located on the computer housing and operationally aligned with the transmitter coil.

2. The portable computer of claim 1, the computer housing including a housing cover and a housing body, where the housing cover includes a top side and a bottom side, where a computer display is located on the bottom side.

3. The portable computer of claim 2, the housing cover where the transmitter coil is located beneath the housing cover on the top side.

4. The portable computer of claim 3, where the transmitter coil is integrated into the housing cover.

5. The portable computer of claim 3, where the transmitter coil is located proximate a central area of the housing cover top side.

6. The portable computer of claim 3, the top side of the computer housing including an indicia, where the transmitter coil is located directly below the indicia.

7. The portable computer of claim 3, comprising an electromagnetic shield layer located within the computer housing between the wireless charger and the computer display.

8. The portable computer of claim 3, where the computer housing topside includes a first area and a second area, where the first area includes a charging area.

9. The portable computer of claim 8, where the computer housing first area has a first area thickness and the second area has a second area thickness, where the first area thickness in the charging area is less than the second area thickness.

10. The portable computer of claim 8, where the charging area is made of a first material composition and the second area is made of a second material composition, where the first material composition is more magnetically transmissive than the second material composition.

11. The portable computer of claim 10, where the second material composition includes a magnetic amplification layer that aids in magnetically coupling the wireless charging system to a device to be charged.

12. The portable computer of claim 3, comprising where the wireless charging system includes a second transmitter coil.

13. The portable computer of claim 12, where the second transmitter coil is located beneath the housing cover on the top side.

14. The portable computer of claim 3, where the transmitter coil is located within the computer body housing.

15. The portable computer of claim 14, where the computer body housing includes a keyboard area and a mouse pad area, where the transmitter coil is located within the computer body housing outside of the keyboard area and the mousepad area.

16. The portable computer of claim 1, comprising a power system, where the computer power system is coupled to the wireless charging system.

17. A portable computer comprising:
a computer housing:
a wireless charging system within the computer housing, the wireless charging system including a transmitter circuit coupled to a transmitter coil, where when the wireless charging system is activated the transmitter coil operates to inductively couple to a device located on the computer housing and operationally aligned with the transmitter coil;
the computer housing including a housing cover and a housing body, where the housing cover includes a top side and a bottom side, where a computer display is located on the bottom side; and
a computer power system coupled to the wireless charging system.

18. The portable computer of claim 17, where the computer power system provides AC power to the wireless charging system.

19. The portable computer of claim 17, where when the portable computer is not connected to an AC power supply, AC power is provided to the wireless charging system via a computer battery system.

20. A portable computer comprising:
a computer housing:
a wireless charging system within the computer housing, the wireless charging system including a transmitter circuit coupled to multiple transmitter coils, where when the wireless charging system is activated one of the multiple transmitter coils operates to inductively couple to a device located on the computer housing and operationally aligned with the transmitter coil.

21. The portable computer of claim 20, the computer housing including a housing cover and a housing body, where the housing cover includes a top side and a bottom side, where a computer display is located on the bottom side, and where the multiple transmitter coils are located beneath the housing cover on the top side.
